(19) United States
(12) Patent Application Publication
(10) Pub. No.: US 2025/0237539 A1
(43) Pub. Date: Jul. 24, 2025

(54) SYSTEM AND METHOD FOR FLUID FLOW METER TESTING

(71) Applicant: AIM Oilfield Services, LLC, Pearland, TX (US)

(72) Inventors: Austin Brown, Pearland, TX (US); Tyler James Urbina, Andrews, TX (US); Trampus Joshua Lee, Colorado City, TX (US)

(73) Assignee: AIM Oilfield Services, LLC, Pearland, TX (US)

(21) Appl. No.: 19/033,391

(22) Filed: Jan. 21, 2025

Related U.S. Application Data
(60) Provisional application No. 63/622,368, filed on Jan. 18, 2024.

(51) Int. Cl. G01F 25/10; G01F 1/84; G01F 1/90

(52) U.S. Cl. CPC G01F 25/13; G01F 1/8409; G01F 1/90

(57) ABSTRACT

A flow meter testing system includes a mobile testing platform. The flow meter testing system further includes a rotatable inlet nozzle extending from the mobile testing platform and a rotatable outlet nozzle extending from the mobile testing platform. The flow meter testing system also includes a master flow meter positioned about the mobile testing platform and having a master meter inlet and a master meter outlet, the master meter inlet coupled to the rotatable inlet nozzle and the master meter outlet coupled to the rotatable outlet nozzle. The flow meter testing system further includes wherein the rotatable inlet nozzle is configured to couple to an inlet side of a test flow meter and the rotatable outlet nozzle is configured to couple also to an outlet side of the test flow meter.

### CROSS REFERENCE TO RELATED APPLICATION(S)

This application is a Nonprovisional Patent Application which claims the benefit of and priority to U.S. Provisional Patent Application No. 63/622,368, filed Jan. 18, 2024, the disclosure of which is incorporated herein by reference in its entirety and for all purposes.

### BACKGROUND

Removing a flow meter from service for testing against a master meter can pose several significant problems for industries and operations. Firstly, the economic impact of downtime and lost productivity can be substantial. Many industries rely on continuous flow measurement for critical processes, such as manufacturing, water treatment, and energy production. When a flow meter is taken out of service for testing, the process that it is monitoring or controlling may need to be halted. This downtime can lead to production delays, increased operational costs, and potential revenue losses, especially in industries with tightly scheduled processes. Additionally, the removal of a flow meter for testing can disrupt the operational flow of a system. This can create logistical challenges and require careful planning to minimize disruptions. The interruption of a critical process can affect supply chains, lead to inefficiencies, and even result in the need for costly workarounds.

Furthermore, the removal and testing of flow meters can involve costs associated with labor, transportation, and maintenance. These expenses can be considerable, particularly if specialized personnel and equipment are needed to extract, transport, and reinstall the flow meter. The calibration and testing process itself can also be time-consuming and require skilled technicians. Therefore, the economic and operational impact of removing a flow meter from service for testing highlights the importance of proper planning and scheduling to minimize these disruptions and maintain the overall efficiency and reliability of industrial processes.

### SUMMARY OF THE INVENTION

According to a first aspect a flow meter testing system includes a mobile testing platform, a rotatable inlet nozzle extending from the mobile testing platform, and a rotatable outlet nozzle extending from the mobile testing platform. The system also includes a master flow meter positioned about the mobile testing platform and having a master meter inlet and a master meter outlet, the master meter inlet coupled to the rotatable inlet nozzle and the master meter outlet coupled to the rotatable outlet nozzle. The system further includes wherein the rotatable inlet nozzle is configured to couple to an inlet side of a test flow meter and the rotatable outlet nozzle is configured to couple also to an outlet side of the test flow meter.

In many embodiments, the system further includes a pump positioned within the mobile testing platform and having a pump outlet coupled to the master meter inlet.

According to some embodiments, the system further includes a mobile testing platform storage tank having a tank outlet coupled to a pump inlet.

In other embodiments, the system further includes at least one sensor coupled to the master meter outlet and positioned proximate to the master flow meter.

According to many embodiments, the at least one sensor is a thermocouple.

In some embodiments, the master flow meter is a Coriolis master meter.

According to other embodiments, the master flow meter is a turbine master meter.

In some other embodiments, the rotatable inlet nozzle is a 90-degree fitting.

According to some other embodiments, the rotatable outlet nozzle is a 90-degree fitting.

According to a second aspect a method of using a mobile master flow meter testing system includes the steps of providing a mobile master flow meter testing assembly having an exterior portion and an interior portion, the interior portion includes a rotatable inlet nozzle, a rotatable outlet nozzle, and a master flow meter that includes a master meter inlet coupled to an interior end of the rotatable inlet nozzle and a master meter outlet coupled to an interior end of the rotatable outlet nozzle. The method further includes the step of positioning the mobile master flow meter testing assembly proximate to a test flow meter. The method further includes the step of coupling an exterior end of the rotatable inlet nozzle to an inlet side of the test flow meter. The method further includes the step of coupling an exterior end of the rotatable outlet nozzle to an outlet side of the test flow meter. The method further includes the step of pumping a fluid through the flow meter and the master flow meter. The method further includes the step of recording a flow rate sensed by the test flow meter and a master flow rate sensed by the master flow meter. The method further includes the step of comparing the recorded flow rate with the recorded master flow rate.

In many embodiments, the method further includes the step of based on the compare, if the recorded flow rate is different from the recorded master flow rate by an error amount, then calibrating the test flow meter.

According to some embodiments, the master flow meter is a Coriolis master meter.

In other embodiments, the master flow meter is a turbine master meter.

According to many embodiments, the rotatable inlet nozzle is a 90-degree fitting.

In some embodiments, the exterior portion of the mobile master flow meter testing assembly includes at least two wheels.

According to a third aspect a mobile master flow meter testing apparatus includes a mobile testing platform and a master flow meter positioned about the mobile testing platform and having a master meter inlet and a master meter outlet. The apparatus also includes a rotatable inlet nozzle coupled to the master meter inlet and a rotatable outlet nozzle coupled to the master meter outlet. The apparatus further includes wherein the rotatable inlet nozzle is configured to couple to an inlet side of a test flow meter and the rotatable outlet nozzle is configured to couple to an outlet side of the test flow meter.

In many embodiments, the apparatus further includes a pump positioned about the mobile testing platform and having a pump outlet coupled to the master meter inlet.

According to some embodiments, the apparatus further includes a storage tank positioned about the mobile testing platform and having a tank outlet coupled to a pump inlet of the pump.

In other embodiments, the rotatable outlet nozzle is a 90-degree fitting.

According to many other embodiments, the rotatable inlet nozzle is configured to rotate at least about 90 degrees.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a flow diagram of an out-of-service testing system.

FIG. 2 is a flow diagram of an in-service testing system.

FIG. 3 is a flow diagram of an in-service testing system utilizing the test tank and test pump.

FIG. 4 is a flow diagram of an in-service testing system with a control system.

FIG. 5 is a block flow diagram of a method of utilizing an in-service testing system.

The drawings are not necessarily to scale and certain features may be shown exaggerated in scale or in somewhat schematic form in the interest of clarity and conciseness.

### DETAILED DESCRIPTION

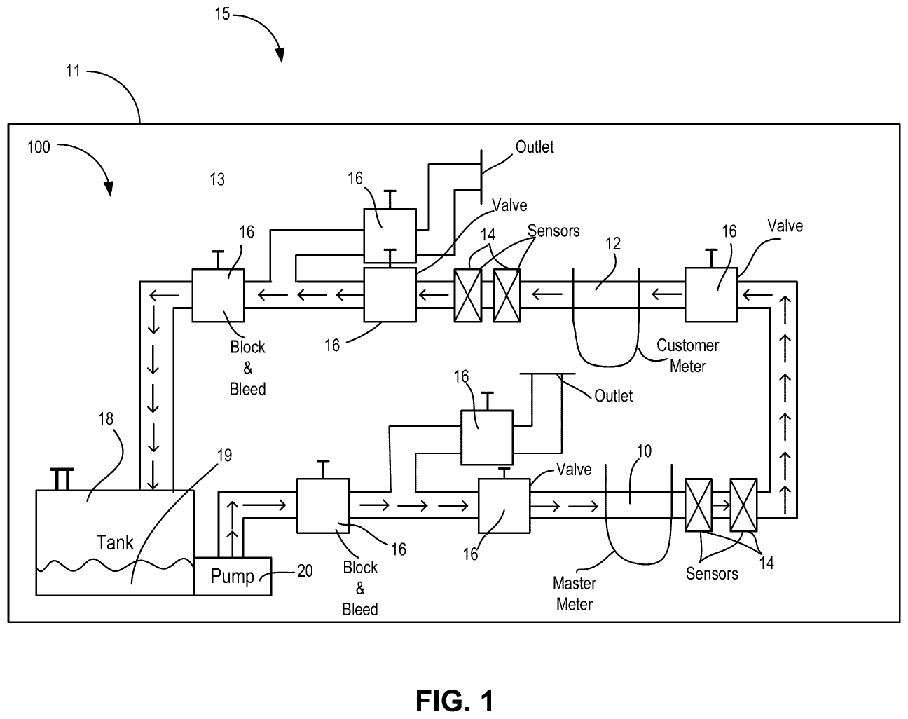

Reference is now made to FIG. 1, which depicts a flow diagram of an out-of-service testing system 100. The name of the out-of-service testing system 100 refers to the fact that the test meter 12 is pulled from service, or otherwise disconnected from its normal operation, to be tested. The out-of-service testing system 100 includes a master meter 10, a test meter 12, sensors 14, valves 16, a test tank 18, and a test pump 20. The out-of-service testing system 100 is contained on or otherwise secured to the mobile testing platform 11. In operation of the out-of-service testing system 100, the mobile testing platform 11 will be positioned close or proximate to the test meter 12 to minimize the distance that the test meter 12 must be physically transported. Then the test meter 12 will be removed from service, transported to the mobile testing platform 11, and subsequently coupled to, or placed in line with, the system 100 such that the test meter 12 is in fluid communication with the master meter 10. The master meter 10 and the test meter 12 are coupled together such that substantially the same volume or mass that flows through either the master meter 10 or the test meter 12 will likewise flow through the other meter. A test fluid 19 stored within the test tank 18 will then be pumped through both the master meter 10 and test meter 12 by the test pump 20 and the flow rate that each meter registers will be recorded and compared to one another. The out-of-service testing system 100 utilizes the test tank 18 and the test pump 20 as a fluid reservoir and a pressure generating apparatus respectively. The sensors 14 are generally positioned either upstream or downstream oh the master meter 10, the test meter 12, or both and are generally used to verify certain conditions of the flow of the test fluid 19 such as its pressure or temperature. Valves 16 are interspersed throughout the system 100, with there being generally at least one valve 16 upstream and at least one valve 16 downstream of the master meter 10, the test meter 12, or both.

With continued reference to FIG. 1, a mobile testing platform 11 is any suitable platform capable of transporting the system 100 on roads, highways, and the like. The mobile testing platform 11 can be a trailer that is configured to be coupled to a truck and pulled behind the truck. The mobile testing platform 11 can also be directly coupled to a truck such that the mobile testing platform 11 is contained on or about the bed of the truck or another rear portion of a vehicle. The mobile testing platform 11 can also be contained within an enclosed trailer or an enclosed area of a truck. The mobile testing platform 11 includes a interior portion 13 where the various components of the system(s) 100, 102, 104 may be housed and or mounted. The interior portion 13 may be defined by the enclosed space of a trailer or other similar enclosure. Space that is exterior to the mobile testing platform 11 is the exterior portion 15 of the mobile testing platform 11.

A master meter 10 can be any suitable type of flow meter, for example, master meter 10 can be a turbine master meter. Turbine master meters consist of a rotor with blades placed within the fluid flow. As the fluid flows through the meter, the rotor spins, and the rotational speed is directly proportional to the flow rate. Master meter 10 can also be a positive displacement master meter. Positive displacement master meters operate on the principle of trapping a known volume of fluid in a series of chambers and then measuring the number of displacements to determine the flow rate. Master meter 10 can also be a volumetric piston master meter. Volumetric piston master meters use a piston to displace a known volume of fluid. Master meter 10 can also be a rotary vane master meter. Rotary vane master meters use rotating vanes to measure the flow of fluid. They are employed to calibrate other rotary vane flow meters and are known for their accuracy and durability in various applications. Master meter 10 can also be orifice plates with differential pressure transmitters. Orifice plates create a constriction in the flow path, and the differential pressure across the orifice is used to calculate the flow rate. However, any suitable type of master meter 10 may be used herein.

The test meter 12 can be any of the types of master meter 10 described herein. It should be understood, that the test meter 12 can be any type of flow meter. The type of master meter 10 must be compatible with the type of test meter 12 that is being tested such that the results of the flow test are accurate. A flow test is a test that compares the flow rate that is registered by the master meter ten with the flow rate that is registered by the test meter 12. The flow rate that is registered by the test meter 12 is recorded and subsequently compared to the flow rate that was registered by the master meter 10. If the flow rate that was registered by the test meter 12 differs from the flow rate that is registered by the master meter 10 by an amount that is above or exceeds an error threshold, then the test meter 12 is deemed out of spec and is marked to either be replaced or recalibrated. For example, during a flow test if the master meter 10 registers a flow rate of 10 cubic meters per second, and the test meter 12 registers a flow rate of 10.5 cubic meters per second and the error threshold is ±0.3 cubic meters per second, then the test meter 12 would be deemed out of spec and marked to be replaced or recalibrated.

The sensors 14 can be temperature sensors, such as thermocouples. Temperature measurements are important for compensating flow measurements, as the density and viscosity of a fluid can change with temperature. Thermocouples placed within the flow can monitor the temperature of the fluid, allowing for temperature corrections to be applied to the flow measurement. This helps ensure that both the master meter 10 and the test meter 12 provides accurate measurements, taking into account variations in fluid properties due to temperature changes. Additionally, the sensors 14 can include a thermowell which is a protective sheath or tube designed to encase a temperature sensor 14, such as a thermocouple or a thermometer probe, within a process system. A thermowell's primary function is to shield the thermometer probe or thermocouple from the harsh environment of the test fluid 19, ensuring accurate temperature measurements. To verify that a thermocouple is registering the correct temperature, the thermowell allows for periodic calibration checks or replacement of the thermocouple without disrupting the process. The sensors 14 can also be pressure sensors, used to measure the pressure of the test fluid 19 within the system 100. Pressure data can be used for calculating flow rates and ensuring that the master meter 10 operates correctly. Changes in pressure can impact the accuracy of the flow measurement, and pressure sensors can provide real-time feedback on pressure variations. The sensors 14 can also be density sensors as some flow measurement applications require density sensors to directly measure the density of the test fluid 19. Density is another parameter that can influence flow measurement accuracy. The sensors 14 can also be viscosity sensors, which are used when the viscosity of the fluid is a significant factor in the flow measurement. For instance, in industries like petrochemicals or food processing, fluid viscosity can vary considerably. Viscosity sensors help account for these variations to maintain measurement accuracy. The sensors 14 can also be pH sensors and other chemical sensors. In specific applications, pH sensors and other chemical sensors may be used to monitor the chemical composition of the fluid.

Valves 16 are generally used to create a double block and bleed valve configuration with the master meter 10, test meter 12, or both. The double block refers to two separate valves 16, with one set of valves 16 upstream and another set of valves 16 downstream of the section that needs to be isolated. When both valves 16 are closed, they create a double block, sealing off the test fluid 19 in between the two sets of valves 16. In this manner, if one valve 16 in the set of two valves 16 has a small leak or other unwanted ingress of fluid, then the second valve 16 should be sufficient to isolate the piping section upstream or downstream of the double block valves 16. In between the two sets of double block valves 16, there is generally a third valve 16 called a bleed valve 16. This bleed valve 16 is used to vent or drain any fluid that might be trapped between the two sets of double block valves 16 after they are closed. It is also used for pressure relief and to verify that the isolation is successful and that there is effectively zero energy between the double block valves 16.

Valves 16 can also include or be configured as motor-controlled valves 16. Motor-controlled valves 16 are equipped with electric motors that respond to signals from pressure sensors or control systems. When the pressure in the system 100, 102, 104 deviates from a desired setpoint, the motor-controlled valve 16 adjusts its position to either restrict or allow more fluid flow, which in turn modulates the pressure within the system 100, 102, 104. This autonomous regulation ensures that the pressure remains within specified parameters. The ability to automate pressure control through motor-controlled valves 16 enhances overall system 100, 102, 104 reliabilities, reduces manual intervention, and optimizes overall operational performance.

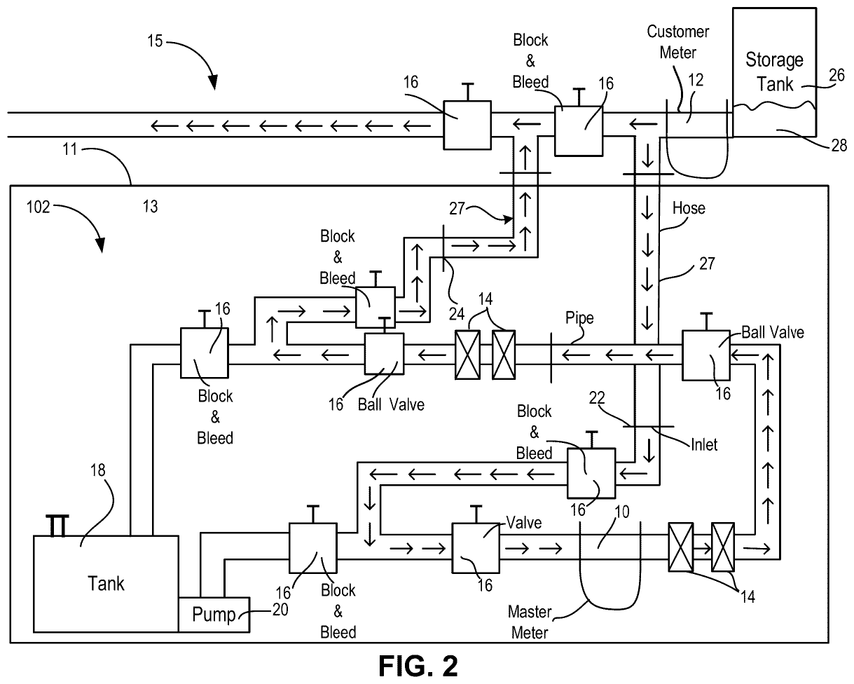

Reference is now made to FIG. 2, which depicts a flow diagram for an in-service testing system 102. The in-service testing system 102 is functionally similar to the out-of-service testing system 100 with like components serving the same or functionally similar roles. The differences between the out-of-service testing system 100 and the in-service testing system 102 will be described herein. One difference between the in-service testing system 102 and the out-of-service testing system 100 is that with the in-service testing system 102, the test meter 12 is not removed from its service to perform the flow test. Another difference is the use of a rotatable inlet nozzle 22 and a rotatable outlet nozzle 24 to couple to the respective inlet piping 23 and outlet piping 25 of the test meter 12. Another difference from the out-of-service testing system 100 is that the in-service testing system 102 utilizes the in-service storage tank 26 to provide the in-service fluid 28 for the flow test.

In operation, the mobile testing platform 11 is positioned proximate to the test meter 12, such that the rotatable inlet nozzle 22 can be coupled to the inlet side 23 of the test meter 12 by a hose 27, or any other suitable piping connection, and the rotatable outlet nozzle 24 can be coupled to the outlet side 25 of the test meter 12 by a hose 27. The test meter 12 is isolated from the in-service fluid 28 in the in-service storage tank 26 by at least one valve 16 upstream and another valve 16 downstream of the test meter 12. Then, the inlet side 23 of the test meter 12 is coupled to the rotatable inlet nozzle 22 by the hose 27 and the outlet side 25 of the test meter 12 is coupled to the rotatable outlet nozzle 22 by hose 27. Then, the valve 16 upstream of the test meter 12 is opened such that the in-service fluid 28 may flow freely from the storage tank 26 through both the test meter 12 and the master meter 10 simultaneously. Readings from the test meter 12 and master meter 10 regarding the flow of the in-service fluid 28 through the respective meters are then recorded and compared to one another.

The in-service testing system 102 is generally utilized in situations where the in-service fluid 28 in the storage tank 26 has sufficient pressure to flow the in-service fluid 28 through the test meter 12 and master meter 10 without the need for the test pump 20. The in-service testing system 102 can also be utilized in situations where the in-service storage tank 26 includes an in-service pump that is configured to pump the in-service fluid 28 at a flow rate that is compatible with the master meter 10 specifically and the in-service testing system 102 generally. In certain embodiments of the in-service testing system 102, the valve 16 downstream of the test meter 12 can be opened such that fluid may flow downstream of the test meter 12 as in normal operation of test meter 12. In utilizing the in-service testing system 102, there can be considerable time savings by not having to remove the test meter 12 from service, transport it to a flow meter testing assembly, perform the flow test, and then reinstall the test meter 12 in its service.

It should be understood, that while the in-service testing system 102 is depicted as utilizing the rotatable inlet nozzle 22 and rotatable outlet nozzle 24, other configurations are also envisioned. For example, the out-of-service testing system 100 may also utilize the rotatable inlet nozzle 22 and the rotatable outlet nozzle 24 when coupling to the test meter 12, master meter 10, or any other suitable component. With continued reference to FIG. 2, it should be understood that while the rotatable inlet nozzle 22 is depicted as being coupled to the inlet piping 23 upstream of the test meter 12, other configurations are also envisioned. The rotatable inlet nozzle 22 may also be coupled to the outlet piping 25 downstream of the test meter 12. In such embodiments the rotatable outlet nozzle 24 would similarly be coupled to the inlet piping 23 upstream of the test meter 12.

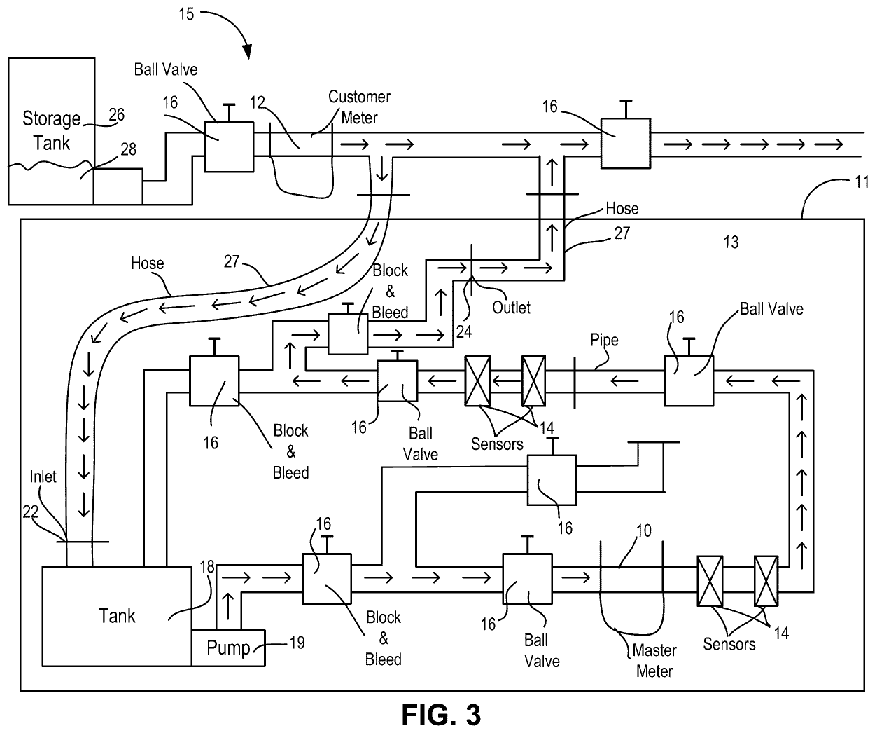

Reference is now made to FIG. 3, which depicts a flow diagram of another embodiment of an in-service testing system 104. The in-service testing system 104 operates similarly to the in-service testing system 102 except for the use of the test tank 18 and test pump 20 instead of the in-service storage tank 26. The rotatable inlet nozzle 22 is coupled to the inlet piping 23 upstream of the test meter 12 on one end and to the test tank 18 on the other end. This connection allows for the test tank 18 to be filled with the in-service fluid 28 stored within the interior of the in-service storage tank 26. The rotatable outlet nozzle 24 is coupled to the outlet piping 25 downstream of the test meter 12. After the test tank 18 is filled with a sufficient amount of the in-service fluid 28 to conduct a flow test, the in-service fluid 28 is then pumped through the in-service testing system 104 by the test pump 20 to conduct the flow test. To ensure a closed system, once the test tank 18 is filled with an amount of the in-service fluid 28 that is sufficient to conduct the flow test, the valves 16 upstream and downstream of the test meter 12 are closed or blocked off during the flow test.

Alternatively, with respect to FIG. 3, the flow test may also be conducted with the use of the test fluid 19. In such embodiments, the valves 16 positioned upstream and downstream of the test meter 12 are both closed or blocked off prior to either coupling the inlet piping 23 to the rotatable inlet nozzle 22 or coupling the outlet piping 25 to the rotatable outlet nozzle 24. The rotatable inlet nozzle 22 is coupled to the inlet piping 23 by hose 27 or other suitable piping spool piece and the rotatable outlet nozzle 24 is coupled to the outlet piping 25 by hose 27 or other suitable piping spool piece connection. Then the flow test may be conducted by pumping the test fluid 19 through the system 104 with the test pump 20. The flow rates registered by the test meter 12 and the master meter 10 are each respectively recorded and subsequently compared to one another. If the flow rate registered by the test meter 12 is different from the flow rate registered by the master meter 10 and the difference is above an error threshold, the test meter 12 is deemed out of spec and will be marked to be either replaced or recalibrated.

With continued reference to FIG. 3, it should be understood that while the rotatable inlet nozzle 22 is depicted as being coupled to the inlet piping 23 upstream of the test meter 12, other configurations are also envisioned. The rotatable inlet nozzle 22 may also be coupled to the outlet piping 25 downstream of the test meter 12. In such embodiments the rotatable outlet nozzle 24 would similarly be coupled to the inlet piping 23 upstream of the test meter 12.

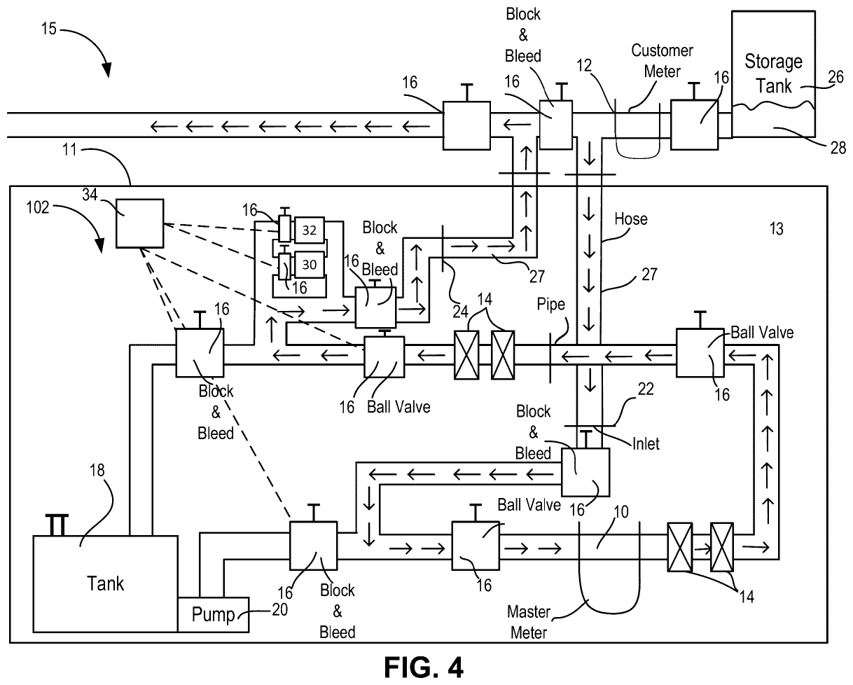

Reference is now made to FIG. 4, which depicts a flow diagram of an in-service testing system 102 with a control system 34. The system 100, 102, 104 can further include a control system 34 communicatively coupled to the sensors 14, the heat exchanger 30, the heater 32, and the motor controlled valves 16. The control system 34 analyzes data received from the sensors 14 regarding the physical properties of the test fluid 19 (e.g., temperature, pressure, etc.) and determines if the test fluid's 19 physical properties are optimized for running a flow test. If the physical properties of the test fluid 19 are optimized for a flow test, then the control system 34, alerts the user or operator that a flow test is ready to be conducted. If the physical properties of the test fluid 19 are not optimized for a flow test, the control system 34 analyzes the physical properties of the test fluid 19 to determine if adjusting the temperature or pressure of the test fluid 19. If the control system 34 determines that a temperature adjustment is necessary, then the control system 34 will send or transmit an electronic signal to orient the motor-controlled valves 16 such that the test fluid 19 is routed through the heater 32 to raise the temperature of the test fluid 19 or through the heat exchanger 30 to lower the temperature of the test fluid 19, depending on the appropriate type of temperature adjustment that is deemed necessary. If the control system 34 determines that adjusting the pressure of the test fluid 19 is necessary, the control system 34 will send or transmit an electronic signal to orient the motor-controlled valves 16 such that the pressure of the test fluid 19 is increased or decreased, depending on the appropriate type of pressure adjustment that is deemed necessary. Once the adjustment has been made, the control system 34 will reanalyze data received from the sensors 14 regarding the physical properties of the test fluid 19 to determine if the physical properties of the test fluid 19 are optimized for running a flow test and will alert the user or operator if they are. The control system 34 may adjust the physical properties of the test fluid 19 with a single adjustment for all of the physical properties of the test fluid 19 or the control system 34 may adjust a single physical property of the test fluid 19 at a time until the physical properties of the test fluid are optimized for conducting a flow test. In many embodiments, the control system 34 includes an artificial intelligence (“AI”) program that is configured to learn from each successive flow test that is conducted to assist in determining the optimal physical properties of the test fluid 19.

In some implementations, the flow rate of the in-service fluid 28 is greater than or otherwise exceeds the limits for maximum or minimum flow rates for the master meter 10. In such implementations, the control system 34 may determine that a flow rate adjustment is necessary. If the control system 34 determines that adjusting the flow rate of the in-service fluid 28 is necessary, then the control system 34 will send or transmit an electronic signal to orient the motor-controlled valves 16 such that the flow rate of the in-service fluid 28 is increased or decreased, depending on the appropriate type of flow rate adjustment that is deemed necessary. Once the adjustment has been made, the control system 34 will reanalyze data received from the sensors 14 regarding the physical properties of the in-service fluid 28 to determine if the physical properties of the test fluid 19 are optimized for running a flow test and will alert the user or operator if they are. The control system 34 can be configured to send an alert or alarm to the operator if the flow rate exceeds certain limits when compared to the beginning of the test. For example, the control system 34 can be configured to alert the operator if the flow rate increases 10% above the flow rate that the fluid had at the beginning of the flow test. It should be understood, that any target such as 10% increase in flow rate, 10% decrease in flow rate, 5% increase in flow rate, 5% decrease in flow rate, or any other suitable or desirable target may be utilized to alert the operator of changing flow rate conditions during the flow test. In some implementations, such a feature is utilized as an early leak detection system. When the control system 34 recognizes or registers a decrease in flow rate, pressure, temperature, or any other physical property of the fluid measured or detected by sensors 14, an alert may be sent to the operator to check the various piping connections for any leaks. Adjusting the flow rate of the in-service fluid 28 also allows for the control system 34 to control how much product or fluid flows through the system 100, 102, 104 at any time.

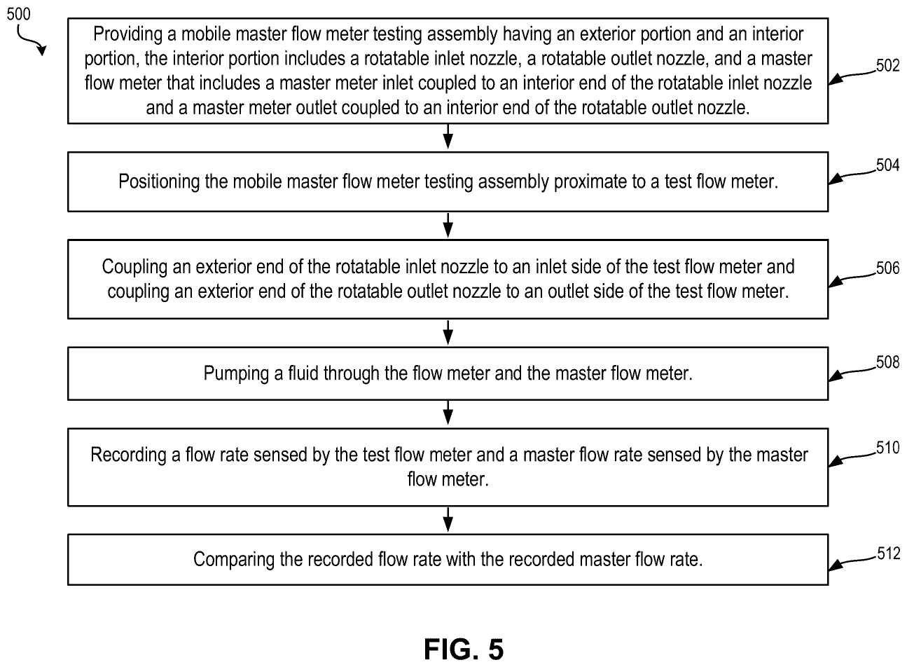

The out-of-service system 100 and the in-service system 102, 104 can also include a heater 32 positioned inline with the master meter 10, as shown in FIG. 5. The heater 32 is configured to heat the fluid flowing through the systems 100, 102, 104 to a specific temperature to more accurately replicate process fluid conditions that the test meter 12 normally operates under. Ensuring that the test fluid 19 is at the same or substantially similar temperature helps to ensure that the test meter 12 accurately records fluid flow at normal operating temperatures. Additionally, the systems 100, 102, 104 can also include a heat exchanger 30 positioned inline with the master meter 10 configured to cool the fluid flowing through the systems 100, 102, 104 to a specific temperature. In addition to ensuring that the test fluid 19 is flowing through the system at a temperature that is substantially similar to the normal operating conditions that the test meter 12 operates under, heat exchanger 30 also operates as an added safety measure. Some in-service fluids 28 may enter the system 100, 102, 104 at an elevated temperature and if a leak were to occur, may cause injury to users or operators positioned within the mobile testing platform 11. Thus, by routing the in-service fluid 28 through the heat exchanger 32, the temperature of the in-service fluid 28 can be brought down to a safer level if a leak were to occur.

Reference is now made to FIG. 5, which depicts a block flow diagram of a method 500 of using an in-service testing system 102, 104. The method 500 begins at step 502 by providing a mobile master flow meter testing assembly having an exterior portion and an interior portion, the interior portion includes a rotatable inlet nozzle 22, a rotatable outlet nozzle 24, and a master flow meter 10 that includes a master meter inlet coupled to an interior end of the rotatable inlet nozzle 22 and a master meter outlet coupled to an interior end of the rotatable outlet nozzle 24. The method 500 also includes step 504 by positioning the mobile master flow meter testing assembly proximate to a test flow meter 12. The method 500 continues at step 506 by coupling an exterior end of the rotatable inlet nozzle 22 to an inlet side of the test flow meter 12 and coupling an exterior end of the rotatable outlet nozzle 24 to an outlet side of the test flow meter 12. The method 500 continues at step 508 by pumping a fluid through the flow meter 12 and the master flow meter 10. The method 500 continues at step 510 by recording a flow rate sensed by the test flow meter 12 and a master flow rate sensed by the master flow meter 10. The method 500 concludes at step 512 by comparing the flow rate recorded by the test meter 12 with the flow rate recorded by the master meter 10. It should be understood that while the method 500 is described as a method for utilizing an in-service testing system 102, 104, other configurations are also envisioned. For example, the method 500 can also be utilized to conduct a flow test with the out-of-service testing system 100.

Although embodiments of an out-of-service testing system 100 and an in-service testing system 102, 104 and method 400 have been described in detail, those skilled in the art will also recognize that various substitutions and modifications may be made without departing from the scope and spirit of the appended claims.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and “right,” “front” and “rear,” “above” and “below” and the like are used as words of convenience to provide reference points and are not to be construed as limiting terms.

In this specification, the word “comprising” is to be understood in its “open” sense, that is, in the sense of “including,” and thus not limited to its “closed” sense, that is the sense of “consisting only of.” A corresponding meaning is to be attributed to the corresponding words “comprise,” “comprised” and “comprises” where they appear.

In addition, the foregoing describes some embodiments of the disclosure, and alterations, modifications, additions and/or changes can be made thereto without departing from the scope and spirit of the disclosed embodiments, the embodiments being illustrative and not restrictive.

Furthermore, the disclosure is not to be limited to the illustrated implementations, but to the contrary, is intended to cover various modifications and equivalent arrangements included within the spirit and scope of the disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A flow meter testing system, the system comprising:
a mobile testing platform;
a rotatable inlet nozzle extending from the mobile testing platform;
a rotatable outlet nozzle extending from the mobile testing platform;
a master flow meter positioned about the mobile testing platform and having a master meter inlet and a master meter outlet, the master meter inlet coupled to the rotatable inlet nozzle and the master meter outlet coupled to the rotatable outlet nozzle; and
wherein the rotatable inlet nozzle is configured to couple to an inlet side of a test flow meter and the rotatable outlet nozzle is configured to couple also to an outlet side of the test flow meter.

2. The flow meter testing system as in claim 1, further comprising a pump positioned within the mobile testing platform and having a pump outlet coupled to the master meter inlet.

3. The flow meter testing system as in claim 2, further comprising a mobile testing platform storage tank having a tank outlet coupled to a pump inlet.

4. The flow meter testing system as in claim 1, further comprising at least one sensor coupled to the master meter outlet and positioned proximate to the master flow meter.

5. The flow meter testing system as in claim 4, wherein the at least one sensor is a thermocouple.

6. The flow meter testing system as in claim 1, wherein the master flow meter is a Coriolis master meter.

7. The flow meter testing system as in claim 1, wherein the master flow meter is a turbine master meter.

8. The flow meter testing system as in claim 1, wherein the rotatable inlet nozzle is a 90-degree fitting.

9. The flow meter testing system as in claim 1, wherein the rotatable outlet nozzle is a 90-degree fitting.

10. A method of using a mobile master flow meter testing system, the method comprising:
providing a mobile master flow meter testing assembly having an exterior portion and an interior portion, the interior portion includes a rotatable inlet nozzle, a rotatable outlet nozzle, and a master flow meter that includes a master meter inlet coupled to an interior end of the rotatable inlet nozzle and a master meter outlet coupled to an interior end of the rotatable outlet nozzle;
positioning the mobile master flow meter testing assembly proximate to a test flow meter;
coupling an exterior end of the rotatable inlet nozzle to an inlet side of the test flow meter;
coupling an exterior end of the rotatable outlet nozzle to an outlet side of the test flow meter;
pumping a fluid through the flow meter and the master flow meter;
recording a flow rate sensed by the test flow meter and a master flow rate sensed by the master flow meter; and
comparing the recorded flow rate with the recorded master flow rate.

11. The method of claim 10, further comprising based on the compare, if the recorded flow rate is different from the recorded master flow rate by an error amount, then calibrating the test flow meter.

12. The method of claim 10, wherein the master flow meter is a Coriolis master meter.

13. The method of claim 10, wherein the master flow meter is a turbine master meter.

14. The method of claim 10, wherein the rotatable inlet nozzle is a 90-degree fitting.

15. The method of claim 10, wherein the exterior portion of the mobile master flow meter testing assembly includes at least two wheels.

16. A mobile master flow meter testing apparatus, the apparatus comprising:
a mobile testing platform;
a master flow meter positioned about the mobile testing platform and having a master meter inlet and a master meter outlet;
a rotatable inlet nozzle coupled to the master meter inlet;
a rotatable outlet nozzle coupled to the master meter outlet; and
wherein the rotatable inlet nozzle is configured to couple to an inlet side of a test flow meter and the rotatable outlet nozzle is configured to couple to an outlet side of the test flow meter.

17. The apparatus of claim 16, further comprising a pump positioned about the mobile testing platform and having a pump outlet coupled to the master meter inlet.

18. The apparatus of claim 17, further comprising a storage tank positioned about the mobile testing platform and having a tank outlet coupled to a pump inlet of the pump.

19. The apparatus of claim 16, wherein the rotatable outlet nozzle is a 90-degree fitting.

20. The apparatus of claim 16, wherein the rotatable inlet nozzle is configured to rotate at least about 90 degrees.
